(19) United States
(12) Patent Application Publication
(10) Pub. No.: US 2018/0219230 A1
(43) Pub. Date: Aug. 2, 2018

(54) Cathode Having Active Catalyst Particles Supported on Nanotubes and Methods of Making the Same

(71) Applicant: Nissan North America, Inc., Franklin, TN (US)

(72) Inventors: Nilesh Dale, Novi, MI (US); Cenk Gumeci, Walled Lake, MI (US)

(21) Appl. No.: 15/420,935

(22) Filed: Jan. 31, 2017

(51) Int. Cl. H01M 4/92; H01M 8/1004; H01M 4/88

(52) U.S. Cl. CPC H01M 4/926; H01M 8/1004; H01M 2004/8689; H01M 4/8817; H01M 2250/20; H01M 4/8825

(57) ABSTRACT

Methods of preparing a cathode for a fuel cell include growing nanotubes on a substrate, the nanotubes of a material that is electron conductive; aligning the nanotubes such that the nanotubes extend from the substrate with a free distal end opposite the substrate; and depositing an active catalyst particle on the free distal end of each of the nanotubes. A membrane electrode assembly includes a cathode comprising a layer of electron conducting nanotubes extending from the electrode membrane and aligned such that a free distal end of each electron conducting nanotube is closer to the gas diffusion layer than the electrode membrane; an active catalyst particle attached to the free distal end of each electron conducting nanotube, wherein a diameter of the active catalyst particle is greater than a diameter of a respective electron conducting nanotube; and ionomer between each active catalyst particle and the gas diffusion layer.

### TECHNICAL FIELD

This disclosure relates to electrodes for fuel cells having active catalyst particles supported on nanowires to improve oxygen transport to the active catalyst particles.

### BACKGROUND

Fuel cells efficiently and electrochemically convert fuel into electric current, which may then be used to power electric circuits, such as drive systems for vehicles. A fuel cell containing a proton exchange membrane is an electrochemical device that converts chemical energy to electrical energy using, for example, hydrogen or methane as fuel and oxygen/air as oxidant.

Fuel cells have membrane electrode assemblies comprising a membrane with an anode on one side and a cathode on the other side. On the anode side, the catalyst enables hydrogen molecules to be split into protons and electrons. On the cathode side, the catalyst enables oxygen reduction by reacting with the protons generated by the anode, producing water. Due to pressure to reduce cost of fuel cells, amounts of active catalyst material such as platinum have been reduced while balancing fuel cell efficiency. Poor oxygen transport to the active catalyst particles impacts the efficiency of the fuel cell.

### SUMMARY

Disclosed herein are methods of preparing a cathode having active material particles supported on nanowires, making the active material particles accessible to oxygen supplied to the cathode. Also disclosed are membrane electrode assemblies having active material particles supported on nanowires, the membrane electrode assemblies having improved oxygen contact with the active material particles.

One method of preparing a cathode as disclosed herein comprises growing nanotubes on a substrate, the nanotubes of a material that is electron conductive; aligning the nanotubes such that the nanotubes extend from the substrate with a free distal end opposite the substrate; and depositing an active catalyst particle on the free distal end of each of the nanotubes, wherein the active catalyst particle has a diameter greater than a diameter of a respective nanotube.

One embodiment of a membrane electrode assembly as disclosed herein comprises an electrode membrane; an anode on one side of the electrode membrane; a cathode on an opposing side of the electrode membrane; and a gas diffusion layer on the cathode opposite the electrode membrane. The cathode comprises a layer of electron conducting nanotubes extending from the electrode membrane and aligned such that a free distal end of each electron conducting nanotube is closer to the gas diffusion layer than the electrode membrane; an active catalyst particle attached to the free distal end of each electron conducting nanotube, wherein a diameter of the active catalyst particle is greater than a diameter of a respective electron conducting nanotube; and ionomer between each active catalyst particle and the gas diffusion layer.

Another embodiment of a membrane electrode assembly as disclosed herein comprises an electrode membrane; an anode on one side of the electrode membrane; a cathode on an opposing side of the electrode membrane; and a gas diffusion layer on the cathode opposite the electrode membrane. The cathode comprises a layer of electron conducting nanotubes extending from the electrode membrane and aligned such that a free distal end of each electron conducting nanotube is closer to the gas diffusion layer than the electrode membrane. An active catalyst film is attached to the free distal end of the electron conducting nanotubes, the active catalyst film having a thickness of between 2 nm and 3 nm, inclusive. Ionomer is between the active catalyst film and the gas diffusion layer.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of a cross-section of a fuel cell stack.

FIG. 2 is schematic of a membrane electrode assembly.

FIG. 3 is a cross-sectional schematic of a membrane electrode assembly as disclosed herein.

FIG. 4 is a cross-sectional schematic of another embodiment of a membrane electrode assembly as disclosed herein.

FIG. 5 is a cross-sectional end view of an embodiment of the membrane electrode assembly of FIG. 3.

FIG. 6 is a flow diagram of a method of making a membrane electrode assembly as disclosed herein.

### DETAILED DESCRIPTION

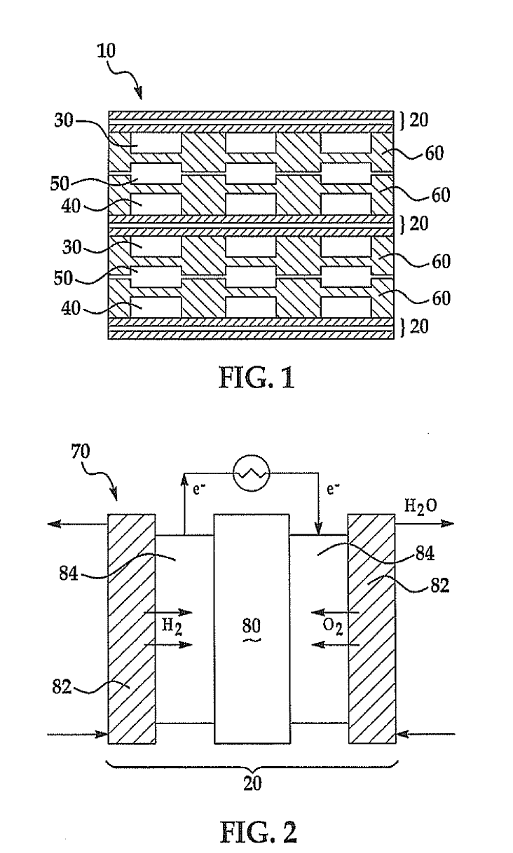

FIG. 1 shows a schematic cross-sectional illustration of a portion of a fuel cell stack 10. The illustration is provided as an example and is not meant to be limiting. The fuel cell stack 10 is comprised of multiple membrane electrode assemblies 20. Fuel 30 such as hydrogen is fed to the anode side of a membrane electrode assembly 20, while an oxidant 40 such as oxygen or air is fed to the cathode side of the membrane electrode assembly 20. Coolant 50 is supplied between the fuel 30 and oxidant 40, the coolant 50 separated from the fuel 30 and oxidant 40 by separators 60.

FIG. 2 is an illustration of one of the plurality of fuel cells 70 in the fuel cell stack 10. The fuel cell 70 is comprised of a single membrane electrode assembly 20. The membrane 80 has a catalyst layer 84 formed on opposing surfaces of the membrane 80, such that when assembled, the catalyst layers 84 are each between the membrane 80 and a gas diffusion layer 82. Alternatively, a gas diffusion electrode is made by forming a catalyst layer 84 on a surface of each of two gas diffusion layers 82 and sandwiching the membrane 80 between the gas diffusion layers 82 such that the catalyst layers 84 contact the membrane 80.

The gas diffusion layers 82 are typically one or more types of carbon material, including, but not limited to, non-woven carbon fiber paper or woven carbon cloth. The gas diffusion layers 82 provide conductivity and assist the feed gas and oxidant to come in contact with the catalyst layers 84.

The catalyst layers 84 contain catalyst comprising active catalyst material such as platinum and other noble metals, transitional metals, metal oxides, and alloys thereof. Non-limiting examples of active catalyst material include Pt, Pt—Co, Pt—Ni, Pt—Cu and Pt—Fe. Conventional catalyst also comprises conventional support material for the active catalyst material, typically carbon particles or other conductive particles, with the active catalyst material deposited on the surface of the support particles. The catalyst is layered on one of the membrane 80 and the gas diffusion layers 82. The catalyst layer 84 has a thickness of between about 100 nm and 10 microns, with the active catalyst material distributed throughout the thickness of the catalyst layer 84. Oxygen enters the catalyst layer 84 of the cathode through the gas diffusion layer 82. The oxygen is reduced at the active catalyst material to form water with hydrogen protons. Active catalyst particles in the catalyst layer 84 near the gas diffusion layer 82 are accessible to oxygen. However, active catalyst particles within the layer and near the membrane 80 are less accessible as oxygen transport through the catalyst layer is not consistent through the life of the fuel cell.

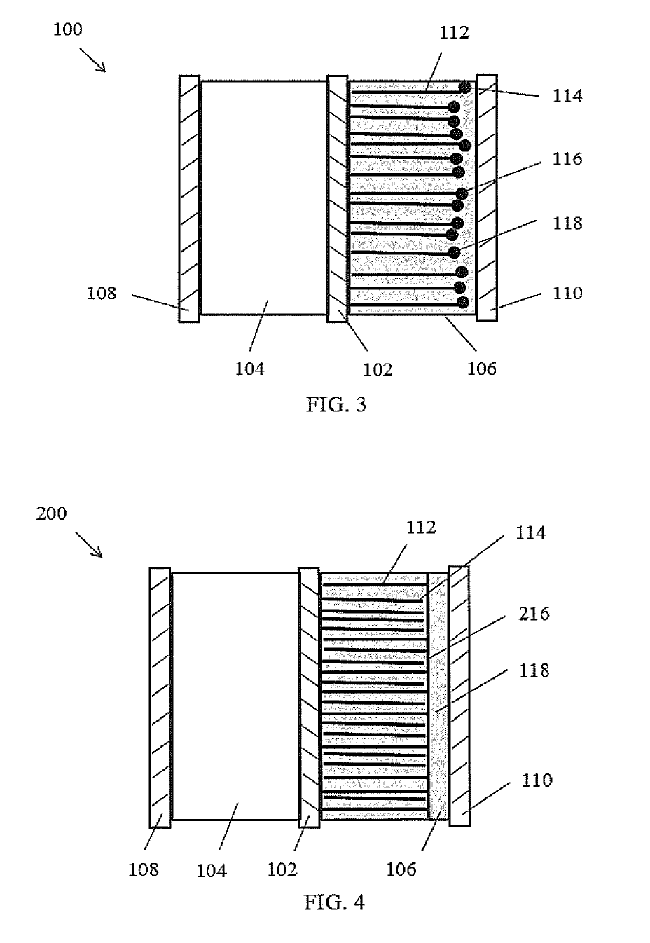

The methods and membrane electrode assemblies disclosed herein provide a catalyst layer with active catalyst material readily and consistently accessible to the oxygen supplied to the cathode. As illustrated in FIG. 3, a membrane electrode assembly 100 includes an electrode membrane 102, an anode 104 on one side of the electrode membrane 102, a cathode 106 on an opposing side of the electrode membrane 102, a gas diffusion layer 108 on the anode 104 opposite the electrode membrane 102, and a gas diffusion layer 110 on the cathode 106 opposite the electrode membrane 102. The cathode 106 comprises a layer of electron conducting nanotubes 112 extending from the electrode membrane 102 and aligned such that a free distal end 114 of each electron conducting nanotube 112 is closer to the gas diffusion layer 110 than the electrode membrane 102.

The cathode 106 can have a thickness ranging between about 100 nm to 10 microns. The electrode conducting nanotubes 112 can have a length L ranging between 80% and 98% of the thickness of the cathode 106. One end of each electrode conducting nanotube 112 is in contact with the electrode membrane 102 with the distal end 114 of each electron conducting nanotube 112 extending toward the gas diffusion layer 110. The electron conducting nanotubes 112 can be so aligned as to be substantially perpendicular to the electrode membrane 102.

As used herein, the term “electron conducting nanotubes 112” includes nanowires, nanorods and other similar nano-structures. The electron conducting nanotubes 112 can be solid or hollow, or a mixture of both. The electron conducting nanotubes 112 can be a carbon material or an electron conducting non-carbon material. The electron conducting nanotubes 112 can have a diameter Dₙ ranging between about 2 nm-5 nm. The electron conducting nanotubes 112 can be uniform in length L and diameter Dₙ across the cathode 106 or can vary in one or both of diameter Dₙ and length L.

In the embodiment shown in FIG. 3, an active catalyst particle 116 is attached to the free distal end 114 of each electron conducting nanotube 112. A diameter D_{c} of the active catalyst particle 116 is greater than the diameter Dₙ of a respective electron conducting nanotube 112. The diameter D_{c} can range between about 3 nm and 10 nm. The diameter D_{c} of the active catalyst particles 116 can vary within the range. The active catalyst particles 116 can also vary in shape. For example, prismatic shape can provide a tip that can be seated in a hollow nanotube 112. Ionomer 118 is located between each active catalyst particle 116 and the gas diffusion layer 110 to assist in proton transport through the cathode 106. Ionomer 118 can also be between void spaces between each of the electron conducting nanotubes 112. If the electron conducting nanotubes 112 are hollow, ionomer 118 can also fill the hollow electron conducting nanotubes 112.

The embodiment of the membrane electrode assembly 200 shown in FIG. 4, elements are the same as in that of FIG. 3 except that the active catalyst material 216 is a thin film of active material supported by the distal ends 114 of the electron conducting nanotubes 112. The active catalyst material 216 can have a thickness of about 2 nm to 3 nm, with ionomer 118 between the film and the gas diffusion layer 110.

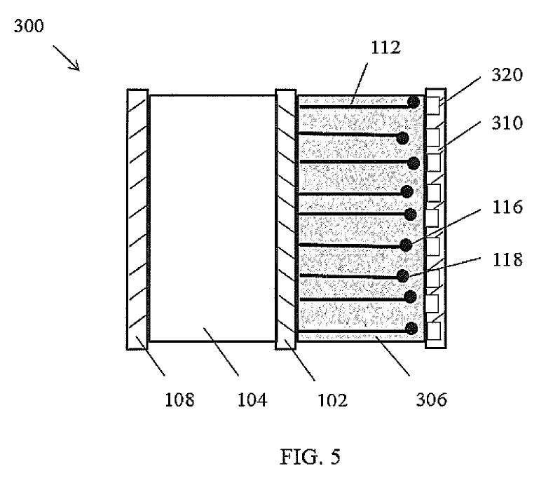

The membrane electrode assembly 100 in FIG. 3 can further have a modified gas diffusion layer 310 as illustrated in FIG. 5. The gas diffusion layer 310 has channels 320 adapted for oxygen flow to the cathode 306, and the electron conducting nanotubes 112 are located on the electrode membrane 102 to be concentrated at the channels 320. The placement of the electron conducting nanotubes 112 in line with the channels 320 delivering oxidant further increases the access of the active material particles 116 to the oxygen.

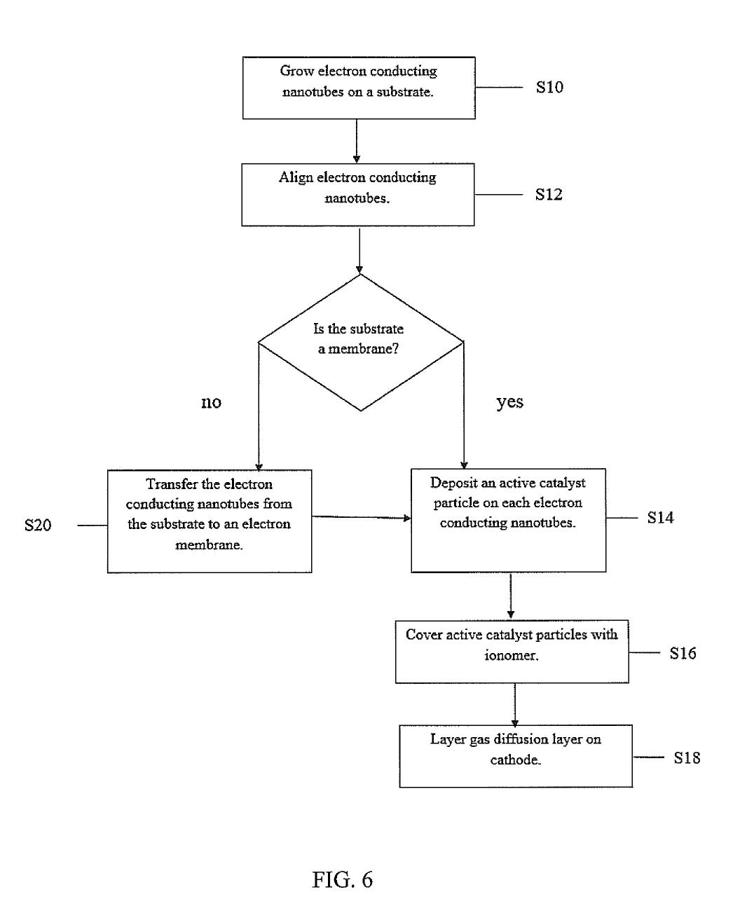

A method of preparing the cathode 106 in FIG. 3 is shown in the FIG. 6 flow diagram. In step S10, the electron conducting nanotubes 112 are grown on a substrate. In step S12, the electron conducting nanotubes 112 are aligned such that the electron conducting nanotubes 112 extend from the substrate with a free distal end 114 opposite the substrate. An active catalyst particle 116 is deposited on the free distal end 114 of each of the electron conducting nanotubes 112 in step S14. Each active catalyst particle 116 has a diameter D_{c} greater than the diameter Dₙ of a respective electrode conducting nanotube 112.

The substrate can be the electron membrane 102. When the substrate is the electron membrane 102, the method further comprises covering each active catalyst particle 116 with an ionomer 118 in step S16. The gas diffusion layer 110 is layered on the cathode 106 opposite the electrode membrane 102 in step S18, the ionomer 118 forming a layer between the gas diffusion layer 110 and each active catalyst particle 116.

The method can further comprise adding additional ionomer 118 to voids between the electron conducting nanotubes 112 prior to layering the gas diffusion layer 110. If the electron conducing nanotubes 112 are hollow, the method can further comprise filling the hollow nanotubes 112 with additional ionomer 118 prior to depositing each active catalyst particle 116 on each of the electron conducting nanotubes 118.

If the substrate is not the electron membrane 102, the method further comprises transferring the electron conducting nanotubes 112 from the substrate to an electron membrane 102 in step S120 prior to depositing each active catalyst particle 116 in step S114. Each active catalyst particle 116 is covered with ionomer 118 after depositing each active catalyst particle 116 in step S116. A gas diffusion layer 110 is layered on the cathode 106 opposite the electrode membrane 102 in step S118, the ionomer 118 forming a layer between the gas diffusion layer 110 and each active catalyst particle 116.

The electron conducting nanotubes 112 can be grown and aligned using methods known to those skilled in the art. As a non-limiting example, electrospinning can be used to both grow and align the electron conducting nanotubes 112. If the electron conducting nanotubes 112 are grown with a magnetic material such as carbon, aligning the electron conducting nanotubes 112 can be done using a magnetic field. The electron conducing nanotubes 112 can be aligned to be substantially perpendicular to the electrode membrane 102.

The active catalyst particles 116 can be deposited using any method known to those skilled in the art. As non-limiting examples, the active catalyst particles 116 can be deposited using electro spraying or atomic layer deposition.

The gas diffusion layer 310 can have channels 320 adapted for oxygen flow to the cathode 106. The channels 320 can be made by varying the porosity of the gas diffusion layer 310, with a greater porosity at the channels 320 and less porosity between the channels 320, for example. The electrode conducting nanotubes 112 can be grown on the substrate in a pattern that concentrates the electron conducting nanotubes 112 at the channels 320.

If the active catalyst particles are formed in an active catalyst film 216, the method can comprise layering the active catalyst film 216 on the distal ends 114 of the electron conducting nanotubes 112 rather than depositing individual particles of active catalyst.

For simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

As used herein, the terminology “example,” “embodiment,” “implementation,” “aspect,” “feature,” or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method of preparing a cathode, comprising:
growing nanotubes on a substrate, the nanotubes of a material that is electron conductive;
aligning the nanotubes such that the nanotubes extend from the substrate with a free distal end opposite the substrate; and
depositing an active catalyst particle on the free distal end of each of the nanotubes, wherein the active catalyst particle has a diameter greater than a diameter of a respective nanotube.

2. The method of claim 1, wherein the substrate is an electron membrane, the method further comprising:
covering each active catalyst particle with an ionomer; and
layering a gas diffusion layer on the cathode opposite the electrode membrane, the ionomer forming a layer between the gas diffusion layer and each active catalyst particle.

3. The method of claim 2, further comprising:
adding ionomer to voids between the nanotubes prior to layering the gas diffusion layer.

4. The method of claim 2, wherein the nanotubes are hollow, the method further comprising:
filling the hollow nanotubes with ionomer prior to depositing the active catalyst particle on each of the nanotubes.

5. The method of claim 2, wherein each nanotube is grown with a height after alignment that ranges between 80% and 98% a distance between the electrode membrane and the gas diffusion layer.

6. The method of claim 2, wherein the nanotubes are aligned to be substantially perpendicular to the electrode membrane.

7. The method of claim 2, wherein the gas diffusion layer has channels adapted for oxygen flow to the cathode, and wherein the nanotubes are grown on the electrode membrane in a pattern that concentrates the nanotubes at the channels.

8. The method of claim 1, wherein the nanotubes are grown and aligned using electro spinning.

9. The method of claim 1, wherein the nanotubes are a magnetic material, and aligning comprises using a magnetic field.

10. The method of claim 1, wherein the active catalyst particles are deposited using electrospraying or atomic layer deposition.

11. The method of claim 1, wherein the nanotubes comprise carbon.

12. The method of claim 1, further comprising:
transferring the nanotubes from the substrate to an electron membrane prior to depositing each active catalyst particle;
covering each active catalyst particle with an ionomer after depositing each active catalyst particle; and
layering a gas diffusion layer on the cathode opposite the electrode membrane, the ionomer forming a layer between the gas diffusion layer and each active catalyst particle.

13. A membrane electrode assembly, comprising:
an electrode membrane;
an anode on one side of the electrode membrane;
a cathode on an opposing side of the electrode membrane; and
a gas diffusion layer on the cathode opposite the electrode membrane, the cathode comprising:
a layer of electron conducting nanotubes extending from the electrode membrane and aligned such that a free distal end of each electron conducting nanotube is closer to the gas diffusion layer than the electrode membrane;
an active catalyst particle attached to the free distal end of each electron conducting nanotube, wherein a diameter of the active catalyst particle is greater than a diameter of a respective electron conducting nanotube; and
ionomer between each active catalyst particle and the gas diffusion layer.

14. The membrane electrode assembly of claim 13, wherein the cathode has a thickness, and the electrode conducting nanotubes have a length ranging between 80% and 98% of the thickness of the cathode.

15. The membrane electrode assembly of claim 13, wherein the cathode further comprises ionomer between void spaces between each of the electron conducting nanotubes.

16. The membrane electrode assembly of claim 13, wherein the electron conducting nanotubes are hollow and filled with ionomer.

17. The membrane electrode assembly of claim 13, wherein the active catalyst material is platinum or a platinum alloy.

18. The membrane electrode assembly of claim 13, wherein the electron conducting nanotubes are aligned to be substantially perpendicular to the electrode membrane.

19. The membrane electrode assembly of claim 13, wherein the gas diffusion layer has channels adapted for oxygen flow to the cathode, and wherein the electron conducting nanotubes are located on the electrode membrane to be concentrated at the channels.

20. A membrane electrode assembly, comprising:
an electrode membrane;
an anode on one side of the electrode membrane;
a cathode on an opposing side of the electrode membrane; and
a gas diffusion layer on the cathode opposite the electrode membrane, the cathode comprising:
a layer of electron conducting nanotubes extending from the electrode membrane and aligned such that a free distal end of each electron conducting nanotube is closer to the gas diffusion layer than the electrode membrane, a length of each electron conducing nanotube being substantially similar;
an active catalyst film attached to the free distal end of the electron conducting nanotubes, the active catalyst film having a thickness of between 2 nm and 3 nm, inclusive; and
ionomer between the active catalyst film and the gas diffusion layer.
